(19) United States
(12) Patent Application Publication
(10) Pub. No.: US 2025/0334857 A1
(43) Pub. Date: Oct. 30, 2025

(54) IMAGING APPARATUS

(71) Applicant: DENSO CORPORATION, Kariya-city (JP)

(72) Inventor: Kohei KUNO, Kariya-city (JP)

(21) Appl. No.: 19/188,875

(22) Filed: Apr. 24, 2025

(30) Foreign Application Priority Data
Apr. 26, 2024 (JP) 2024-073227

(51) Int. Cl. G03B 11/04

(52) U.S. Cl. CPC G03B 11/045

(57) ABSTRACT

An imaging apparatus includes a receptacle, a lens that is received in the receptacle and is configured to capture light from an exterior of the receptacle, an imager that is disposed within the receptacle and inward from the lens and is configured to capture images of the exterior of the receptacle based on light captured by the lens, an imager substrate that is disposed within the receptacle and inward from the lens and is configured to control the imager, and a sun visor device that includes at least one sun visor disposed in front of one of surfaces of the lens to partially block light from entering the lens.

### CROSS-REFERENCE TO RELATED APPLICATION

This application is based on and claims the benefit of priority from earlier Japanese Patent Application No. 2024-073227 filed Apr. 26, 2024, the description of which is incorporated herein by reference.

### BACKGROUND

### Technical Field

This disclosure relates to an imaging apparatus, particularly suitable for application to an on-board camera device or a stereo camera for Light Detection and Ranging (LiDAR).

### Related Art

Conventionally, an imaging system and a vehicle window for use with the imaging system are known, where the imaging system includes a member in front of a camera mounted to the vehicle for forward visibility, for example, a blade that wipes the surface of the front windshield.

### BRIEF DESCRIPTION OF THE DRAWINGS

In the accompanying drawings:

FIG. 1 is a block diagram of a camera system to which a camera device according to a first embodiment is applied;

FIG. 2 is a perspective view of the camera device according to the first embodiment;

FIG. 3 is a front view of the camera device illustrated in FIG. 1;

FIG. 4 is a cross-sectional view of the camera device taken along line IV-IV in FIG. 3;

FIG. 5 is a cross-sectional view of the camera device taken along line V-V in FIG. 3;

FIG. 6 is an exploded view of the camera device illustrated in FIG. 2;

FIG. 7 is an illustration of the sun visor when deployed and when stowed;

FIG. 8 is an illustration of the sun visor when in a standby mode, when providing light obscuration, and when stowed;

FIG. 9 is an illustration of a relationship between the focus of expansion (FOE) of an imager and the horizon;

FIG. 10 is an illustration of an example of a positional relationship between the FOE and horizon in image data from the imager, and the sun visor.

### DESCRIPTION OF SPECIFIC EMBODIMENTS

Imaging systems using camera devices are increasingly required to be highly robust so that they can be used for autonomous driving, which is a further advance from driving assistance. Since cameras have a narrower dynamic range than the human eyes, highlights may be blown out when the brightness of captured images reach the upper limit of the image processing capability, leading to saturation of the images, upon receipt of direct sunlight or light from headlights of oncoming vehicles, or shadows may be crushed due to exposure correction.

A known technology to suppress blown highlights or crushed shadows, as disclosed in JP 2019-166964 A, includes use of a blade that wipes the surface of the front windshield covering the front of the camera to obstruct a portion of the capture range. However, the blade of the imaging system as disclosed in JP 2019-166964 A is used as a wiper and does not have a function of intentionally providing light obscuration. Thus, this known technology fails to suppress blown highlights or crushed shadows and accurate imaging data.

In view of the foregoing, it is desired to have an imaging apparatus capable of acquiring accurate imaging data by physically blocking incoming light that causes blown highlights or crushed shadows.

One aspect of the present disclosure provides an imaging apparatus including a receptacle, a lens that is received in the receptacle and is configured to capture light from an exterior of the receptacle, an imager that is disposed within the receptacle and inward from the lens and is configured to capture images of the exterior of the receptacle based on light captured by the lens, an imager substrate that is disposed within the receptacle and inward from the lens and is configured to control the imager, and a sun visor device that includes at least one sun visor disposed in front of one of surfaces of the lens to partially block light from entering the lens.

With the above configuration, the sun visor is disposed in front of the lens, providing light obscuration to a portion of the exposed surface of the lens. Therefore, even in the event where external light such as direct sunlight or light from headlights of oncoming vehicles enters the lens, the sun visor can suppress the external light from entering the lens. This can provide an imaging apparatus capable of acquiring accurate imaging data by physically blocking incoming light that causes blown highlights or crushed shadows.

Hereinafter, embodiments of the present disclosure will be described with reference to the accompanying drawings. In the following embodiments, the same or equivalent parts are assigned the same reference numbers in the drawings, and the same description is adopted for parts with the same reference numbers.

### First Embodiment

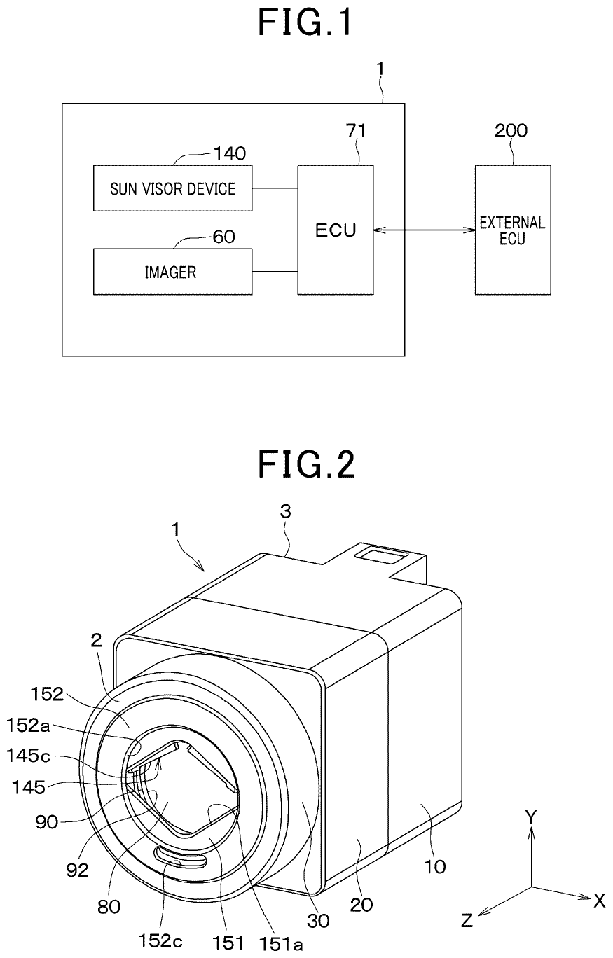

The first embodiment of the present disclosure will now be described. In the present embodiment, the imaging apparatus will be described using a camera device as an example. This camera device is an on-board camera device that is applied, for example, to capture images of the surroundings of a vehicle. For example, a camera device 1 is applied in a camera system configured as illustrated in FIG. 1, and is controlled by communicating with an external electronic control unit (ECU) 200 mounted to the vehicle.

For purposes of illustration, the X-axis, Y-axis and Z-axis are indicated in the accompanying drawings. As illustrated in FIG. 2, X-axis and Y-axis are defined as directions in the tip plane of camera device 1 and as directions perpendicular to one another, and the direction perpendicular to X-axis and Y-axis is referred to as Z-axis. In the Z-axis direction, the end of the camera device 1 where imaging is performed is referred to as the front end, and the end on the opposite side is referred to as the rear end.

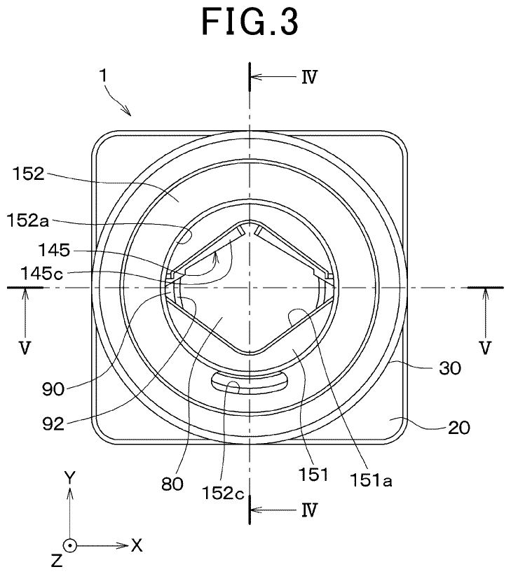

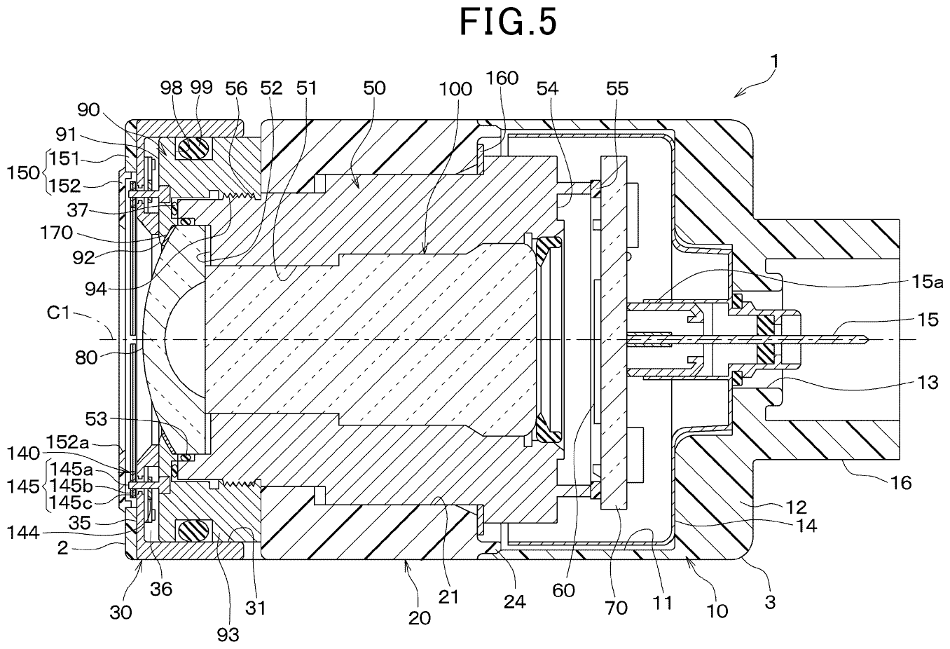

As illustrated in FIGS. 2 to 6, the camera device 1 includes a cover 10, a case 20, a head 30, a lens barrel 50, an imager 60, an imager substrate 70, a lens 80, a lens fixture 90, optical components 100, a sun visor device 140, and a sun visor cover 150.

The cover 10 is a constituent of the receptacle of the camera device 1, and is configured to be a part on the rear end 3 side of the receptacle, opposite from the front end 2 side where the head 30 is disposed. The cover 10 has a rectangular outline shape as viewed from the Z-axis direction, with two sides along the X-axis and two sides along the Y-axis, and has a substantially bottomed rectangular cylindrical shape with an opening on the case 20 side, with the inside being a hollow 11. The material of the cover 10 may be, but is not limited to, a resin. An opening 13 is formed in the center of the bottom 12 of the cover 10. In the hollow 11, the shield member 14 is disposed along the inner wall of the cover 10, and portions of the shield member 14 and the terminal 15 are fitted into the opening 13, with the terminal 15 protruding out of the cover 10. In addition, a connector 16 is formed as a portion of the cover 10 so that it protrudes from the bottom 12 towards the exterior of the camera device 1. When this connector 16 is connected to another connector (not shown), power is supplied to the camera device 1 and the image data captured by the camera device 1 is output to the external ECU 200.

The hollow 11 of the cover 10 receives a portion of the lens barrel 50, the imager 60, and the imager substrate 70. The imager 60 and the imager substrate 70 are surrounded by the shield member 14, which suppresses transmission of external noise to the imager 60 and the imager substrate 70.

A case 20 is a constituent of the receptacle of the camera device 1. As viewed from the Z-axis direction, it has a rectangular outline shape with two sides along the X-axis and two sides along the Y-axis, and it has a substantially rectangular cylindrical shape with a hollow 21 that extends through the interior along the Z-axis. The case 20 may be made of any material, but for example, may be made of a resin. The case 20 receives a portion of the lens barrel 50 and some of the optical components 100 within the hollow 21. The inner wall of the case 20 and the outer surface of the lens barrel 50 are bonded together with an adhesive, etc., thereby providing a seal between them.

At the cover 10 side end of the case 20, an engagement protrusion 24 is formed with slightly smaller external dimensions than the other portions, and the case 20 and the cover 10 are integrated by this engagement protrusion 24 fitting inside the hollow 11 of the cover 10. The outline shapes of the case 20 and the cover 10 are matched. That is, the outer dimensions of the substantially rectangular shapes of the case 20 and the cover 10 are matched, so that the surfaces of the case 20 and the cover 10 that make up a respective side of the substantially rectangular shape share the same plane. The case 20 and the cover 10 are welded at their boundaries and are intimately mated with each other. The joining method is not limited to welding, but may be any other method such as adhesion or press fitting.

Although not shown, a recess extending along the Z-axis is formed in a portion of the inner wall of the case 20. This recess receives a portion of the motor 141 and other components described later that are provided in the sun visor device 140.

A head 30 is a constituent of the receptacle of the camera device 1. As viewed from the Z-axis direction, it has a rectangular outline shape with two sides along the X-axis and two sides along the Y-axis, and it has a substantially rectangular cylindrical shape with a hollow 31 that extends through the interior along the Z-axis. The head 30 may be made of any material, but for example, may be made of a resin. The head 30 receives a portion of the lens barrel 50 and some of the optical components 100, the lens 80, the lens fixture 90, and the sun visor device 140 within the hollow 31. The head 30 engages the outer circumferential surface of the lens fixture 90.

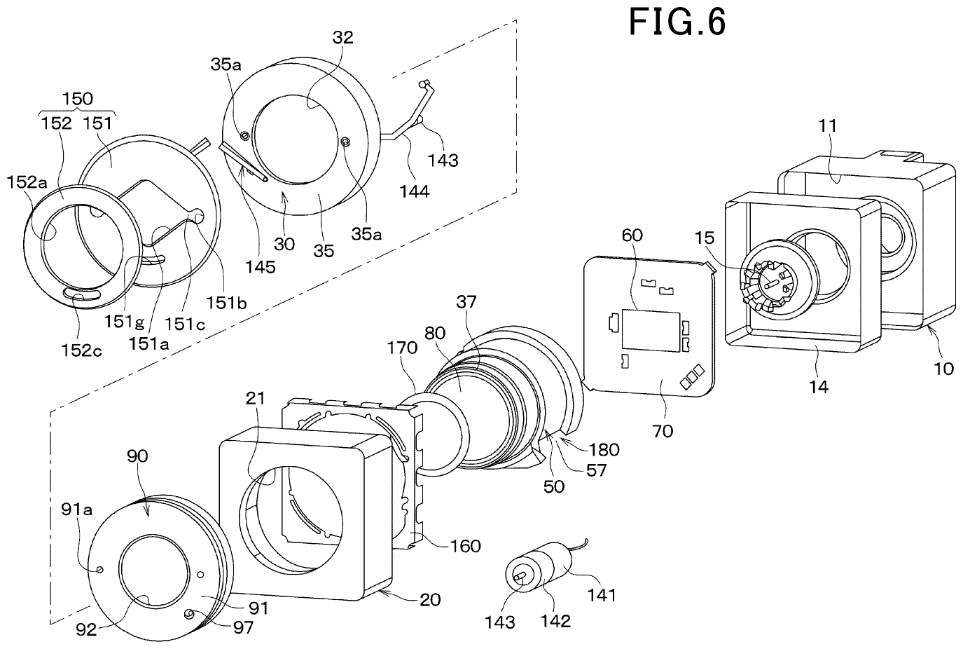

The hollow 31 of the head 30 conforms to the outline shape of the lens fixture 90. The head 30 is attached to the lens fixture 90 by fitting the head 30 to the lens fixture 90. The head 30 has a reduced diameter on the front end 2 side, having a circular opening 32 formed in the center on the front end side 2. A gap 36 is formed between the lens fixture 90 and the front end 2 surface 35 of the head 30 having the opening 32 formed in the surface 35. Furthermore, as illustrated in FIG. 6, through holes 35a are formed in the surface 35, one on each of opposite sides of the hollow 31.

An O-ring 37 is provided between the inner wall surface of the head 30 and the front end of the lens barrel 50, thereby providing a seal between them.

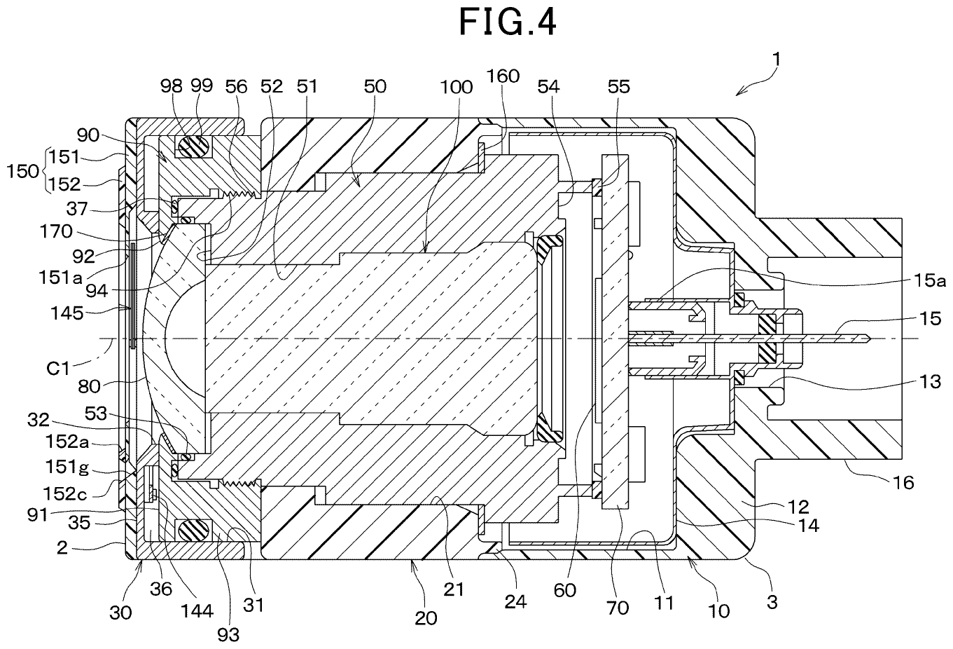

As illustrated in FIGS. 4 to 6, a metal grounding spring 160 is provided at the boundary between the cover 10 and the case 20. This grounding spring 160 prevents the lens barrel 50 from rattling against the case 20 and also prevents external noise from being transmitted to the imager 60 and the imager substrate 70.

The lens barrel 50 corresponds to a housing that conveys the light received by the lens 80 to the imager 60. The lens barrel 50 has a cylindrical shape, here a substantially cylindrical shape, having a hollow 51 extending through the lens barrel 50 along the Z-axis direction, and is made of metal, such as aluminium. The optical axis of the lens barrel 50 is parallel to the direction along the Z-axis, here the Z-axis.

The lens barrel 50 holds the lens 80 and other optical components 100 in a desired positional relationship, that is, a positional relationship in which the light is focused on the imager 60. Although not shown, within the hollow 51 of the lens barrel 50, a plurality of optical components 100 are disposed along the Z-axis and held by the inner wall surface of the lens barrel 50. On the front end 2 side of the lens barrel 50, a lens holder 52 is formed, which is recessed from the front end 2 side to the rear end 3 side. The inner wall dimension of the lens holder 52 is larger than the inner wall dimension of the lens barrel 50 at the position where the optical components 100 are disposed. Disposing the lens 80 within this lens holder 52 allows the lens 80 to be in contact with the front end of the lens barrel 50. An O-ring 53 is disposed around the outer circumference of the lens 80 in the lens holder 52 of the lens barrel 50, sealing between the lens 80 and the lens barrel 50 and positioning the lens 80 in the XY plane.

A recess 54 in which the imager 60 is disposed is formed on the rear end 3 side of the lens barrel 50, and furthermore, the rear end 3 side of the lens barrel 50 is bonded to the imager substrate 70 via an adhesive material 55. In this manner, the lens 80 and the optical components 100 are positioned in a desired positional relationship with respect to the imager 60, and the light captured by the lens 80 is input to the imager 60 to be in focus.

Furthermore, as illustrated in FIG. 6, a semi-cylindrical recess 57 extending along the Z-axis is also formed in a portion of the outer wall of the lens barrel 50. This recess 57 is connected to the recess of the case 20 and receives portions of the motor 141 and other components described later, which are provided in the sun visor device 140.

The imager 60, in other words the image sensor, is a sensing element and is configured by a CMOS, a CCD, or the like. The imager 60 is disposed inside the receptacle rather and rearward of the lens 80 and constitutes an imaging unit that receives light through the lens 80 and the optical components 100 and captures images of objects reflected in the lens 80. The imager 60 has a rectangular shape with the X-axis direction as a longitudinal direction and the Y-axis direction as a lateral direction, and is disposed so that the lens 80 and the imager 60 overlap as viewed from the Z-axis direction.

The imager substrate 70 is a substrate that includes various elements and other electronic components for driving the imager 60 and on which the ECU 71 illustrated in FIG. 1 is mounted. The imager substrate 70, as with the imager 60, is disposed inside the receptacle and rearward of the lens 80. The imager substrate 70 is a substantially rectangular plate-like substrate that includes two sides along the X-axis and two sides along the Y-axis, and the imager 60 is mounted on its surface, specifically, on the front end 2 side surface.

On the other side of the imager substrate 70, opposite the imager 60, a terminal 15 is connected to the imager substrate 70 for supplying power to the imager 60 and various elements on the imager substrate 70, and for outputting image data captured by the imager 60. The ECU 71 on the imager substrate 70 drives the motor 141 described later included in the sun visor device 140, and is also capable of driving the motor 141 based on power supply from the terminal 15. Specifically, a terminal support member 15a is connected to the other side of the imager substrate 70, and the terminal 15 is fitted within the terminal support member 15a. The terminal 15 protrudes out of the cover 10 through the opening 13 of the cover 10.

The lens 80 is positioned outermost of the camera device 1, including the other optical components 100, with one side of the lens 80 exposed to the exterior. The optical axis of the lens 80 is in alignment with the optical axis of the lens barrel 50. For example, the lens 80 is a convex lens whose center is convex on the front end 2 side with respect to the periphery, and is disposed at the front end of the lens barrel 50. The lens 80 may be made of glass. The convex surface on the front side of the lens 80 is an exposed surface that is exposed through the opening 32 of the head 30 and the opening 92 described later in the lens fixture 90 to capture light from the exterior of the camera device 1.

The lens fixture 90 is a member that fixes the lens 80 to the front end of the lens barrel 50. The lens fixture 90 may be made of metal.

The lens fixture 90 is configured in the shape of a bottomed cylinder, with a circular opening 92 formed in the center of the bottom 91, which presses the periphery of the lens 80 against the lens barrel 50 side at the portion of the bottom 91 that is surrounding the opening 92. Specifically, the portion of the bottom 91 that is surrounding the opening 92 has a curved or conical trapezoidal inner wall surface that conforms to the shape of the lens 80 and presses the lens 80 against the lens barrel 50 side. Although the lens fixture 90 may be configured to directly contact the lens 80 and press the lens 80 against the lens barrel 50 side, a gasket 170 may be included between the lens fixture 90 and the lens 80 taking into account manufacturing tolerances of each component. That is, since the lens fixture 90 may fail to press the lens 80 against the lens barrel 50 side reliably due to manufacturing tolerances of the lens 80, the lens fixture 90, or the lens barrel 50, the gasket 170 may be interposed to absorb such manufacturing tolerances. The gasket 170 is a hollow thin conical plate made of a soft material, such as copper.

A female screw thread 94 is formed on the inner wall of the cylindrical portion 93 of the lens fixture 90, and a male screw thread 56 is formed on the outer circumference on the front end side of the lens barrel 50. In a state where the lens 80 and the gasket 170 are positioned at the front end of the lens barrel 50, the lens fixture 90 is rotated and fitted over the front end of the lens barrel 50. The female screw thread 94 and the male screw thread 56 are fastened, and the lens fixture 90 is fixed to the front end, on the lens 80 side, of the lens barrel 50. The lens 80 is fixed in such a manner that it is held between the lens fixture 90 and the front end of the lens barrel 50. Since the gasket 170 is disposed between the lens fixture 90 and the lens 80, the gasket 170 functions as a thread position adjuster, and the lens 80 is properly fixed at a desired position between the lens barrel 50 and the lens fixture 90. That is, although it is necessary to align the thread start positions of the male screw thread 56 and the female screw thread 94 and to align positions of the rotational direction of the male screw thread 56 and the female screw thread 94 after fastening, the sensitivity of the screw axial force to angle can be reduced when the gasket 170, which is made of a soft material such as copper, is disposed. Thus, the degree of freedom of the fastening angle of the lens fixture 90 in the rotational direction of the male screw thread 56 and the female screw thread 94 is increased, fascinating adjustment of thread positions of the male screw thread 56 and the female screw thread 94, thereby allowing the lens 80 to be fixed properly in a desired position.

As illustrated in FIG. 6, a through hole 97 is formed in the bottom 91 of the lens fixture 90 for communication between the lens 80 side and the lens barrel 50 side. The drive shaft 143 of the sun visor device 140 described later is inserted through the through hole 97.

The inner wall surface of the head 30 and the outer circumference of the lens fixture 90 are disposed in contact or with a small gap, and a ring-shaped groove 98 is formed in the part of the outer circumference of the lens fixture 90 that overlaps with the inner wall surface of the head 30, and an O-ring 99 is fitted within the groove 98. This O-ring 99 is in contact with the inner wall surface of the head 30, and a seal is provided between the head 30 and the lens fixture 90.

The optical components 100 are disposed on the imager 60 side of the lens 80 in the hollow 51 of the lens barrel 50. Although the details are not shown, the optical components 100 are configured by arranging a plurality of lenses in the Z-axis direction. The lens 80 and the optical components 100 collect the captured light and input it to the imager 60. The arrangement, number, and shape of the optical components 100 are arbitrary, but they are set so that the captured light can be focused and input to the imager 60.

The sun visor device 140 is configured as including the motor 141, a gearbox 142, a drive shaft 143, a linkage 144, sun visors 145.

The motor 141 is a source of power for the sun visor device 140, and its drive is controlled by the ECU 71 of the imager substrate 70. The ECU 71 of the imager substrate 70 is capable of adjusting an amount of power supplied to the motor 141, and the motor 141 increases or decreases its rotational speed according to the increase or decrease in the amount of power supplied thereto. The motor 141 has a cylindrical shape, and the built-in motor rotation axis (not shown) is oriented in the Z-axis direction, and the longitudinal direction of the motor 141 is in the Z-axis direction. The motor 141, the gearbox 142 and the drive shaft 143 are arranged to be aligned along the Z-axis direction, that is, along the optical axis of the lens 80, and the dimensions of the motor drive system and of the camera device 1 are downsized. The motor 141, together with the gearbox 142, is housed in the accommodation space 180, which is configured by the recess 57 of the lens barrel 50 and a recess (not shown) of the case 20.

Although an arbitrary type of motor may be applied as the motor 141, a DC motor is applied here. A type of motor capable of detecting a rotation angle to perform drive control may be used as the motor 141. However, monitoring the positions of the sun visors 145 by image analysis, as described later, may not require detection of the rotation angle of the motor 141. Therefore, a DC motor, which is inexpensive and capable of high-speed actuation, is applied as the motor 141.

The gearbox 142 contains a gear mechanism connected to the rotation shaft of the motor 141, and attenuates the motor rotational speed to acquire a desired torque, which is in turn output from the drive shaft 143.

The drive shaft 143 is connected to the linkage 144, and transmits the desired torque converted by the gearbox 142 to the linkage 144 as a drive force. In the present embodiment, since the motor 141 and the gearbox 142 are contained in the accommodation space 180, the drive shaft 143 needs to protrude from the accommodation space 180 to the linkage 144. Therefore, the drive shaft 143 is inserted through the through hole 97 formed in the bottom 91 of the lens fixture 90. The drive shaft 143 is configured to connect two members coaxially, for example. In FIG. 6, the portion of the drive shaft 143 connected to the gearbox 142 and the portion connected to the linkage 144 are depicted separately so that the connection relationship with the linkage 144 can be seen.

The linkage 144 is connected to the sun visors 145 and drives the sun visors 145 based on the drive force transmitted from the drive shaft 143. The linkage 144 is disposed within the gap 36 between the head 30 and the lens fixture 90 and is connected to all of the plurality of sun visors 145. Although the linkage 144 may have an arbitrary structure, it may be, in the present embodiment, U-shaped. The linkage 144 is connected to each of the pair of sun visors 145 through the lower position of the lens 80. The drive shaft 143 is connected to the linkage 144 at the position corresponding to the through hole 97, and the drive force is transmitted to the linkage 144. When the motor 141 is driven and the drive force is transmitted to the linkage 144, each of the sun visors 145 is driven.

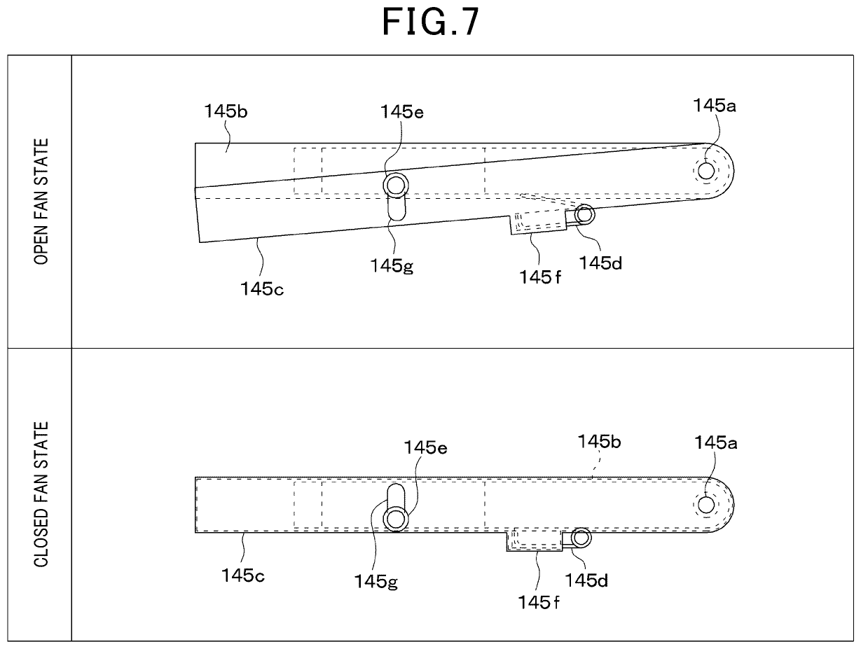

Each sun visor 145 constitutes a light-blocking part that partially blocks the light entering the lens 80, and is disposed in the vertically central region, which is the area near the center of the lens 80 in the vertical direction. This position corresponds to the center area of the imager 60 in the vertical direction, when the lateral direction of the imager 60 is considered to be the vertical direction. In the present embodiment, the sun visors 145 are disposed as a pair, one at a distance on each side of the center of the lens 80. Each sun visor 145 includes a shaft 145a, a blade 145b, a shield member 145c, and a spring 145d, as illustrated in FIG. 7, and has a folding fan structure in which an open fan state and a closed fan state (or stowage state) are switchable.

The shaft 145a is configured to be the center of rotation of the sun visor 145, and the position of this shaft 145a in the sun visor 145 is within the vertically central region of the lens 80. The shaft 145a is disposed in a through hole 35a formed in one surface 35 of the head 30 illustrated in FIG. 6. Through the through hole 35a, the rear end 3 side of the shaft 145a is connected to the linkage 144, and the front end 2 side of the shaft 145a protrudes outward from the head 30. The blade 145b and shield member 145c are attached to this protruding portion. As illustrated in FIG. 6, a recess 91a is formed on one side of the front end 2 side of the bottom 91 of the lens fixture 90 at a position corresponding to the shaft 145a, and the shaft 145a is seated in this recess 91a.

The blade 145b is configured as a rod-shaped member and, in the present embodiment, is an elongated, thin, rectangular flat plate with the longitudinal direction in one direction and the lateral direction orthogonal thereto. The blade 145b is connected to the shaft 145a at one end to serve as the center of rotation, around which the blade 145b swingable within the exposed surface of the lens 80, and the shield member 145c is also connected at the same end. When the linkage 144 is driven based on rotation of the motor, the blade 145b and the shield member 145c are swung around the shaft 145a, partially blocking light from entering the lens 80 by both or either of them.

The shield member 145c is a member for blocking light from entering the lens 80 and is connected to the blade 145b and moves in unison with the blade 145b. In the present embodiment, the shield member 145c is a plate-like member disposed on top of the blade 145b, is an elongated rectangular flat plate with the longitudinal direction in one direction and the lateral direction orthogonal thereto, and is configured to be displaceable with respect to the blade 145b. The shield member 145c may be made of any material as long as it has the function of blocking light from entering the lens 80. For example, it may be made of a material that partially attenuates and transmits light, such as light shielding film. Here, the shape of the shield member 145c matches the shape of the blade 145b and has substantially the same dimensions. The shield member 145c is displaceable by rotating around the shaft 145a with respect to the blade 145b, and the sun visor 145 may be repositioned between an open fan state and a closed fan state (or stowage state), as illustrated in FIG. 7.

In the present embodiment, a spring 145d configured by a torsion spring or the like is provided between the blade 145b and the shield member 145c, a pin 145e is provided on the blade 145b, and a stopper 145f and a guide hole 145g are also provided on the shield member 145c. Specifically, one end of the spring 145d is attached to one side of the blade 145b in the lateral direction, and the other end, which is the other end, is fixed to the stopper 145f included on one side of the shield member 145c in the lateral direction. The pin 145e provided on one side of the blade 145b is configured to be slidable along the guide hole 145g formed in the shield member 145c.

With this configuration, when no force other than the force from the spring 145d is applied to the shield member 145c, the elastic force of the spring 145d acts in the direction of opening the spring, and the sun visors 145 take the form of an open fan, as in the open fan state in FIG. 7. When a force is applied to the shield member 145c from below, the shield member 145c slides against the elastic force of the spring 145d, and the shield member 145c overlaps the blade 145b to form the sun visor 145 with the fan closed, as in the storage unit in FIG. 7. In this way, the shield member 145c can be repositioned.

FIG. 7 illustrates the right one of the pair of sun visors 145 in FIG. 2. The other sun visor 145 is in mirror image to the sun visor in FIG. 7. That is, each of the pair of sun visors 145 is configured such that the shield member 145c slides downward from the blade 145b to be in the open fan state, and the shield member 145c slides upward to the blade 145b to be in the closed fan state.

In the present embodiment, a pair of sun visors 145 are disposed away from each other, on opposing sides of the center of the lens 80. More specifically, the pair of sun visors 145 are disposed lineally symmetrically with respect to a line along the Y-axis passing through the center of the lens 80 as the line of symmetry. The direction in which the pair of sun visors 145 are aligned is the X-axis direction, which coincides with the longitudinal direction of the imager 60 that is rectangular in shape as illustrated in FIG. 6. In the present embodiment, this direction coincides with the horizontal direction when mounted to the vehicle.

The longitudinal direction of the imager 60 is the direction in which the capture range is wider. On the other hand, the direction in which the two sun visors 145 are aligned is the direction in which light can be shielded over a wider capture range. Matching these directions thus allows light blocking of a desired portion of the capture range of the imager 60.

The sun visor cover 150 is provided on the front end 2 side of the sun visors 145. In other words, the sun visor cover 150 is provided on the opposite side of the sun visors 145 from the lens 80. This sun visor cover 150 protects the sun visors 145. The sun visor cover 150 includes a frame 151 and a cap 152 and is directly attached to the head 30. Specifically, the frame 151 is directly attached to one annular surface 35 on the front end 2 side of the head 30, and the cap 152 is attached to the frame 151. The method of attaching the frame 151 to the head 30 is arbitrary. For example, the frame 151 may be bonded to the head 30 with an adhesive, or may have a circular protrusion on the outer edge of the frame 151 and the protrusion is fitted into the head 30.

The frame 151 of the present embodiment is formed of a plate-like member with a rectangular outline shape as viewed from the Z-axis direction. As illustrated in FIG. 6, the frame 151 has an opening 151a formed in a position corresponding to the range of movement of each sun visor 145, and also has shaft holes 151b formed on both sides of the opening 151a in the X-axis direction. Furthermore, the opening 151a and the shaft holes 151b are connected by a notch 151c. The opening 151a has a diamond shape, with the longer of the two intersecting diagonals forming the X-axis direction and the shorter forming the Y-axis direction. The combined range of movement of the two fan-shaped sun visors 145 forms a diamond shape.

The dimensions of the opening 151a are set to be wider than the capture range of the imager 60, so that the capture range is not covered by the frame 151. The shaft hole 151b is formed in a position corresponding to the shaft 145a of the sun visor 145, and is a circular hole through which the shaft 145a is inserted. The notch 151c is formed to widen the gap where the opening 151a and the shaft hole 151b are connected.

The cap 152 is disposed on the front end 2 side of the frame 151, and is annular in shape. The window hole 152a in the cap 152 is circular in shape with a size corresponding to the lens 80, and the opening 151a is exposed through the window hole 152a. The width of the cap 152 and the window hole 152a are dimensioned so that the cap 152 can cover the shafts 145a of the sun visors 145. Although not illustrated, one side of the cap 152, which is on the frame 151 side, has engagement protrusions 152b that protrude toward the rear end 3, and the cap 152 is integrated with the frame 151 by the engagement protrusions 152b being fitted into the shaft holes 151b. The engagement protrusion is not formed at least in a position corresponding to the notch 151c and is shaped in such a way that it does not affect the operation of the sun visor 145.

As illustrated in FIG. 6, a drainage hole 151g is formed in a position adjacent to the opening 151a of the frame 151, and a drainage hole 152c is formed in a position away from the window hole 152a of the cap 152. These drainage holes 151g and 152c are formed in positions corresponding to the earthward position of the lens 80 when the camera device 1 is mounted to a vehicle. The drainage holes 151g and 152c are formed in positions corresponding to each other, and when the cap 152 is attached to the frame 151, they are connected, and the structure is such that the gap between the lens 80 and the frame 151 is connected to the outward side of the cap 152.

Providing such a sun visor cover 150 ensures that the sun visors 145 are disposed inside the frame 151. Therefore, although the blades 145b and the shield members 145c are exposed from the opening 151a, the shafts 145a, etc., are partially covered by the frame 151 and hidden. In the Z-axis direction, the surface of the cap 152 is positioned on the foremost end 2 side, and the sun visors 145 are positioned on the rear end 3 side of the cap 152. This can make it difficult for the blades 145b and the shield members 145c to be subjected to external forces when pushed outward or something external comes into contact with them, thus preventing damage thereto. The camera device 1 of the present embodiment is configured as described above.

### Actuation of Camera Device

The actuation of the camera device 1 and the camera system configured as above will now be described. In a case where the camera device 1 is used on-board, it is applied to capture images of surroundings of a vehicle. For example, the camera device 1 is actuated during travel of the vehicle or during parking assistance, and images are captured by the imager 60 during such time periods.

Specifically, based on instructions from the external ECU 200, the ECU 71 provided on the imager substrate 70 controls capturing of images by the imager 60, and image data captured by the camera device 1 via the terminal 15 is output to the external ECU 200. In the external ECU 200, the image data is analyzed. The analysis results are used for parking assistance, driving assistance during travel, data for recognizing surroundings of the vehicle during autonomous driving.

At this time, even in cases where there is incoming light from the sun or headlights of oncoming vehicles, installation of the sun visors 145 can suppress such incoming light, thus suppressing blown highlights and crushed shadows. In order to position the sun visors 145 in more preferable positions, in the present embodiment, the external ECU 200 actuates the sun visor device 140 as follows based on the analysis results of the image data.

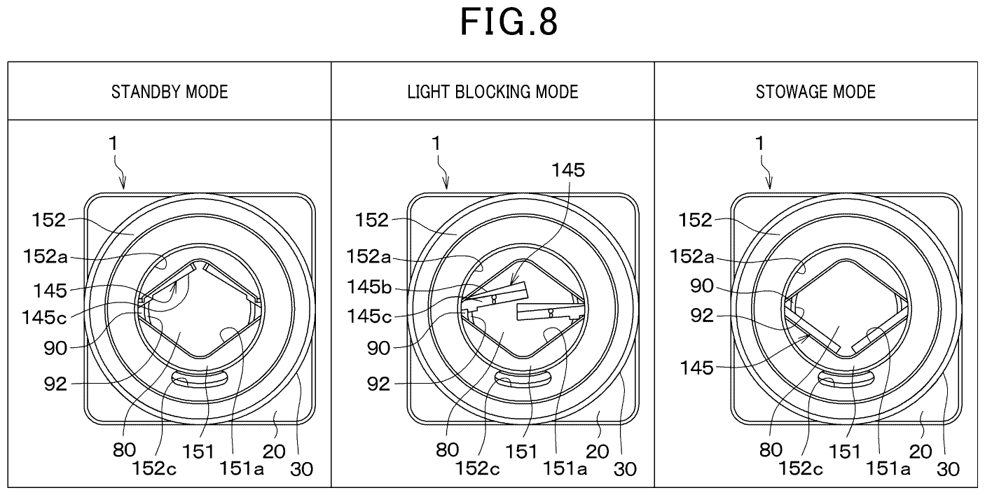

First, when imaging by the imager 60 is started after initiation of driving of the vehicle, or when there is no need to suppress the light entering a specific position based on the imaging data acquired by the imager 60, the sun visor device 140 places the sun visor 145 in a standby mode. That is, the sun visor 145 is moved to the standby position shown in FIG. 8, specifically, to an upper position within the lens 80. In the standby position, no force other than a force applied by the spring member 145d is applied to the shield member 145c. Therefore, the elastic force of the spring member 145d acts in the direction of spreading the shield member 145c, and the sun visor 145 is placed in the open fan state as illustrated in FIG. 7. Thus, a portion of the shield member 145c is exposed from the opening 151a, and the upper portion of the lens 80 is covered.

In addition, in the standby position, the blade 145b can be hidden and stowed between the frame 151 and the lens 80, with the blade 145b positioned along the edge of the opening 151a. Thus, only the shield member 145c is exposed through the opening 151a, and the light entering the lens 80 is not obstructed unnecessarily. In addition, the risk of tampering with the sun visor 145 or contact with something outside the camera device 1 can be reduced, and damage to the sun visor 145 can be prevented.

Next, when blown highlights or crushed shadows are detected in the image data, the external ECU 200 automatically actuates the sun visor device 140 to move the sun visors 145 to where restriction on light entering the lens is needed, for example, to the position where the blown highlights are occurring. This may, for example, move the sun visor 145 to the light-blocking position in FIG. 8, covering where restriction on light entering the lens is needed and restricting the light entering the lens 80. This allows blown highlights and crushed shadows to be suppressed more properly.

Also in this case, the sun visors 145 is placed in the open fan state, since no force other than the force from the spring portion 145d is applied to the shield member 145c. Thus, in this case, the light blocking range is limited when light blocking is performed with a framework component such as the relatively narrow blade 145b, but the shield member 145c can be spread in the direction of sun visor 145 rotation, thereby expanding the light blocking range. This enables light blocking over a wider capture range.

The pair of sun visors 145 are disposed away from and facing each other along the longitudinal direction of the imager 60. This allows a large area within the capture range of the imager 60 to be covered with the sun visors 145. Even when light entering the lens needs to be restricted over a large area, a large portion of the area can be within the light blocking range. The length of the pair of sun visors 145 is set at half to a little more than half of their respective center-of-rotation distances from the viewpoint of avoiding interference, but even with such a length, a wide light blocking range can be provided.

Furthermore, when a length of each of the pair of sun visors 145 is slightly more than half of the distance between their respective rotation centers, the sun visors 145 are actuated at respectively different timings to avoid interfering with each other. For example, FIG. 8 illustrates positions of the pair of sun visors 145 that actuated at respectively different timings. The directions of the sun visors 145, that is, angles formed by the sun visors 145 with respect to the horizontal direction are different. This allows the pair of sun visors 145 to be moved to where restriction on light entering the lens is needed without the pair of sun visors 145 colliding with each other, while still extending the light blocking range.

Of course, even when the lengths of the pair of sun visors 145 are set so that they do not interfere with each other, each sun visor 145 may be actuated at a different timing. In this manner, making the actuation timing different and the angle formed by each sun visor 145 with respect to the horizontal direction different allows accurate blocking of light even when there are a plurality of areas where restriction on light entering the lens is needed.

In a case where the shield member 145c is made of a material that does not completely block light but partially transmits light, the position of the light source causing blown highlights can still be detected even if light from this light source is blocked. This allows the temporal history to be tracked, and the sun visors 145 to be controlled in anticipation.

Furthermore, the sun, which is the main object to be light-blocked, is above the horizon, and a sky with few objects to be recognized is spread out around it. In contrast, since the rotation centers of the pair of sun visors 145 are disposed within the vertically central region of the lens 80, only the upper portion of the capture range can be blocked when the sun is blocked by the sun visors 145. Therefore, a range that is unintentionally blocked by the sun visors 145 may be the sky, which has few objects to be recognized, which may minimize the loss of image data.

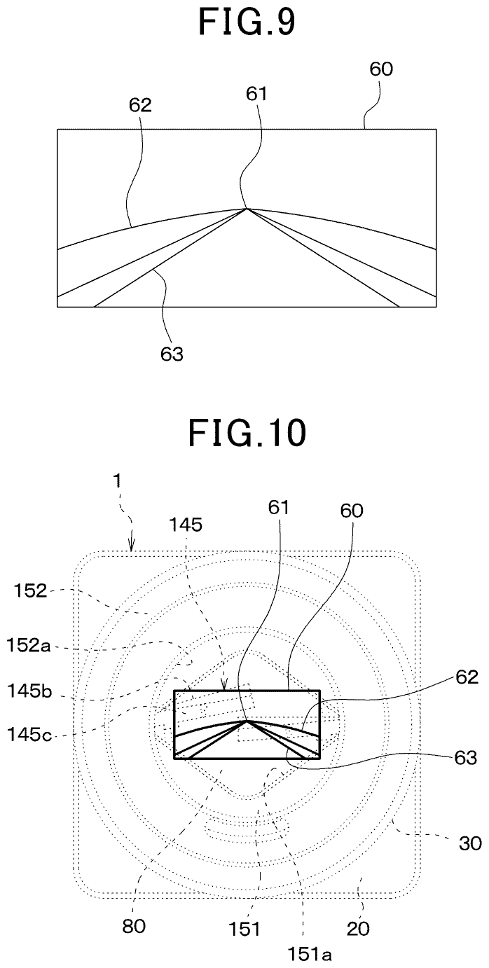

When imaging is performed using the imager 60 during travel of the vehicle, the imaging data is such that the horizon 62 extends in an arc shape centered on the FOE 61, as illustrated in FIG. 9. For example, the white lines 63 of the lane in which the vehicle is traveling are imaged as extending radially from the FOE 61. Thus, in many cases, the headlights of oncoming vehicles are continuously imaged in a radial pattern centered at the FOE 61. By contrast, in the case where each of the pair of sun visors 145 is disposed in the vertically central region of the lens 80 and is made to swing about the shaft 145a as a rotation center, as illustrated in FIG. 10, the sun visor 145 can be disposed so as to face the FOE 61 from the rotation center. Therefore, even when there are a plurality of lights from oncoming vehicles, it is possible to block the light with the same sun visors 145.

When traveling of the vehicle is completed and actuation of the sun visors 145 is completed, each of the sun visors 145 is moved to a stowage position, which is the lower position of the lens 80, as shown in FIG. 8. In the stowage position, each shield member 145c is in contact with the rear end of a stowage portion of the frame 151, for example, the lower side of the opening 151a, and the shield member 145c is subjected to a force in the direction opposite to the elastic force of the spring 145d. Thus, the shield member 145c slides against the elastic force of the spring 145d, and the sun visor 145 is folded as in the stowage mode illustrated in FIG. 8, with the shield member 145c overlapping the blade 145b. This allows the size of the sun visors 145 to be reduced when stowed, thereby reducing the stowage space required.

### Actions and Effects of Camera Device

The sun visors are disposed in front of the lens, providing light obscuration to a portion of the exposed surface of the lens. Therefore, even in the event where external light such as direct sunlight or light from headlights of oncoming vehicles enters the lens, the sun visors can suppress the external light from entering the lens. This can provide an imaging apparatus capable of acquiring accurate imaging data by physically blocking incoming light that causes blown highlights or crushed shadows.

The camera device 1 of this disclosure also provides the following advantages.

(1) Blown highlights and crushed shadows are detected based on image data acquired by the imager 60, and the sun visor device 140 is automatically actuated by identifying where restriction on light entering the lens is needed. Thus, since blown highlights and crushed shadows can be controlled based on image data acquired by the existing imager 60, problems with images can be quickly resolved without additional mechanisms.

In addition, each sun visor 145 has the blade 145b and shield member 145c positioned on the surface of the lens 80 even when the sun visor 145 is in the standby or stowage mode in which the sun visor 145 is not actuated. Therefore, even without an additional mechanism, the current position of the sun visor 145 can be determined based on the image data acquired by the imager 60, and the position control of the sun visor 145 can be accurately performed based on the determined current location.

(2) The sun visors 145 are paired and disposed away from and facing each other along the longitudinal direction of the imager 60. This allows a large area within the capture range of the imager 60 to be covered with the sun visors 145. Even when light entering the lens needs to be restricted over a large area, most of the area can be within the light blocking range.

(3) Setting the length of each of the pair of sun visors 145 to slightly more than half of the distance between their respective rotation centers enables light blocking over a wider area, thus enabling light blocking over the entire capture range of the imager 60. In this case, actuating one of the sun visors 145 at a different timing relative to the other sun visor 145 allows the pair of sun visors 145 to be moved to where restriction on light entering the lens is needed without the pair of sun visors 145 colliding with each other, while still extending the light blocking range.

(4) Using a material that partially transmits light rather than a material that completely blocks light for the shield member 145c allows the position of the light source causing blown highlights to be continuously recognized, even when light from the light source is blocked. This allows the temporal history to be tracked, and the sun visors 145 to be controlled in anticipation.

(5) Each of the pair of sun visors 145 is disposed in the vertically central region of the lens 80 and is made to swing about the shaft 145a as a rotation center. This allows each of the sun visors 145 to be disposed in a direction from the position of the shaft 145a to the FOE 61. Even when there are a plurality of headlights from oncoming vehicles, it is possible to block light from the headlights with the same sun visors 145. In addition, when blocking the sun, only the upper portion of the capture range can be blocked. Therefore, the area that is unintentionally blocked may be the sky with few objects to be recognized, thus minimizing the loss of image data.

(6) The shield member 145c is attached to the blade 145b and the shield member 145c can be spread in the direction of rotation of the sun visor 145. This provides light blocking over a wider area.

(7) In the stowage mode where the sun visors 145 are stowed, the shield members 145c are folded down. This allows the size of each of the sun visors 145 when stowed to be reduced, thereby reducing the stowage space.

(8) The shield member 145c of each of the sun visors 145 is pushed away from the blade 145b by an elastic force. In the standby mode, the sun visor 145 is positioned in the upper position that is in the upward direction. In the stowage mode, the sun visor 145 is positioned in the lower position that is in the downward direction. This allows the shield member 145c to be positioned closer to the center of the lens 80 than the blade 145b in the standby mode, thereby preventing the blade 145b, which is a structural member less transmissive, from narrowing the field of view in the downward direction, where there are many objects to be recognized.

### Other Embodiments

Although the present disclosure has been described in accordance with the above-described embodiments, it is not limited to such embodiments, but also encompasses various variations and variations within equal scope. In addition, various combinations and forms, as well as other combinations and forms, including only one element, more or less, thereof, are also within the scope and idea of the present disclosure.

(1) For example, in the above embodiment, the camera device 1 has been described as an example of an imaging apparatus. Instead, the present disclosure may also be applied to imaging apparatuses such as stereo cameras in LiDAR.

(2) In the above embodiment, the camera device 1 corresponding to the imaging apparatus is an onboard camera for a vehicle, but the present disclosure is not limited to such an onboard camera. However, since there is a demand for downsizing, application of the sun visor device 140 of the present disclosure can contribute to further downsizing.

(3) In the above embodiment, the sun visor device 140 may also be equipped with a light source such as an infrared ray emitter around the lens 80, so that when the surroundings are dark, such as at night, imaging is performed by emitting light and receiving the reflected light in the lens 80.

(4) In the above embodiment, the sun visor device 140 may also serve as a wiper device. For example, a wiper rubber may be provided on the lens 80 side of the blade 145b, and the blade 145b may be used to wipe off deposits that may be present on the surface of the lens 80 by swinging the blade 145b around the shaft 145a. In this case, instead of one component of the blade 145b, an arm may be connected to the shaft 145a and the blade 145b may be suspended by the arm.

(5) In the above embodiment, the lens 80 is exposed to the exterior, but the sun visor device 140 may have a structure in which the periphery or surface of the lens 80 is covered by a guide such as a cover glass, and in such a structure, the sun visor device 140 may be included.

(6) In the above embodiment, each sun visor 145 is configured as including the blade 145b and the shield member 145c separately, and the shield member 145c is configured to be slidable with respect to the blade 145b. In an alternative, the shield member 145c may be fixed to the blade 145b, or the blade 145b itself may function as the shield member 145c.

(7) In each of the above embodiments, image analysis is performed by the external ECU 200, which is located outside the camera device 1, and the sun visor device 140 is driven based on results of this image analysis. In an alternative, this image analysis may be performed by the ECU 71 of the camera device 1. In addition, in each of the above embodiments, the camera device 1 is configured as including the ECU 71. In an alternative, the camera device 1 may be configured as not including the ECU 71. In this case, the various elements on the imager substrate 70 are controlled based on control signals from the external ECU 200, and driving of the imager 60 and the sun visor device 140 is thereby controlled.

(8) It is unnecessary to say that the elements constituting the above embodiments are not necessarily essential unless explicitly stated as essential or obviously considered essential in principle. In addition, when a numerical value such as the number, value, amount, or range of a component(s) of any of the above-described embodiments is mentioned, it is not limited to the particular number or value unless expressly stated otherwise or unless it is obviously limited to the particular number or value in principle, etc. When the shape, direction, positional relationship, or the like of a component(s) or the like of any of the embodiments is mentioned, it is not limited to the shape, positional relationship, or the like unless explicitly stated otherwise or unless it is limited to the specific shape, direction, positional relationship, or the like in principle, etc.

What is claimed is:

1. An imaging apparatus comprising:
a receptacle;
a lens that is received in the receptacle and is configured to capture light from an exterior of the receptacle;
an imager that is disposed within the receptacle and inward from the lens and is configured to capture images of the exterior of the receptacle based on light captured by the lens;
an imager substrate that is disposed within the receptacle and inward from the lens and is configured to control the imager; and
a sun visor device that includes at least one sun visor disposed in front of one of surfaces of the lens to partially block light from entering the lens.

2. The imaging apparatus according to claim 1, wherein
the at least one sun visor is configured by a member that partially attenuates and transmits light.

3. The imaging apparatus according to claim 1, wherein
the imager is rectangular in shape with one direction as a longitudinal direction and a direction orthogonal to the longitudinal direction as a lateral direction,
the at least one sun visor comprises a bar-shaped member that is swingable within one of surfaces of the lens, with one end of the bar-shaped member as a rotation center, and
the at least one sun visor further comprises a pair of sun visors, the pair of sun visors being disposed away from each other along the longitudinal direction of the imager.

4. The imaging apparatus according to claim 3, wherein
one of the pair of sun visors is actuated at a different timing with respect to the other of the pair of sun visors.

5. The imaging apparatus according to claim 3, wherein
each of the pair of sun visors is disposed in a swingable manner from the rotation center toward a focus of expansion of the imager.

6. The imaging apparatus according to claim 3, wherein
the rotation center of each of the pairs of sun visors is disposed in a vertically central region of the lens, with the lateral direction of the imager being a vertical direction.

7. The imaging apparatus according to claim 3, wherein
each of the pair of sun visors has a folding fan structure,
each of the pair of sun visors comprises a shaft that serves as the rotation center, a blade that constitutes the rod-shaped member, and a shield member that is connected to the blade and displaceable with respect to the blade to to place the sun visor in either of an open fan state and a closed fan state, and
each of the pair of sun visors is placed in the open fan state by spreading the shield member in a direction of rotation of the sun visor.

8. The imaging apparatus according to claim 7, wherein
the sun visor device has a stowage mode, and
when the sun visor device is in the stowage mode, each of the pair of sun visors is swung into a stowage position by causing the shield member to be displaced in a direction opposite to a direction of spread of the shield member with respect to the blade, and placing the sun visor in the closed fan state.

9. The imaging apparatus according to claim 7, wherein
a lateral direction of the imager is a vertical direction,
in a standby position of the sun visor device where the pair of sun visors are positioned at an upper position of the lens, the shield member of each of the pair of sun visors spreads to place the sun visor in the open fan state, in which state the shield member blocks light from entering a portion of the lens,
in a stowage position of the sun visor device where the pair of sun visors are positioned at a lower position of the lens, the shield member of each of the pair of sun visors is displaced in a direction opposite to a direction of spread of the shield member with respect to the blade to place the sun visor in the closed fan state.

10. The imaging apparatus according to claim 9, further comprising:
a sun visor cover disposed on an opposite side of the pair of sun visors from the lens and configured to cover the pair of sun visors at least partially,
the sun visor cover comprises a frame having an opening formed to expose the pair of sun visors,
in the standby position of the sun visor device, the blade of each of the pair of sun visors is hidden between the frame and the lens, and
in the stowage position of the sun visor device, the shield member is in contact with the frame and displaced in the direction opposite to the direction of spread of the shield member.

11. The imaging apparatus according to claim 1, wherein
the sun visor device is automatically actuated based on an imaging result from the imager to cover where restriction on light entering the lens is needed with the at least one sun visor.

12. The imaging apparatus according to claim 1, wherein
the imaging apparatus is an on-board camera device for a vehicle.

13. The imaging apparatus according to claim 2, wherein
the imager is rectangular in shape with one direction as a longitudinal direction and a direction orthogonal to the longitudinal direction as a lateral direction,
the at least one sun visor comprises a bar-shaped member that is swingable within one of surfaces of the lens, with one end of the bar-shaped member as a rotation center, and
the at least one sun visor further comprises a pair of sun visors, the pair of sun visors being disposed away from each other along the longitudinal direction of the imager.

14. The imaging apparatus according to claim 3, wherein
one of the pair of sun visors is actuated at a different timing with respect to the other of the pair of sun visors.

15. The imaging apparatus according to claim 13, wherein
each of the pair of sun visors is disposed in a swingable manner from the rotation center toward a focus of expansion of the imager.

16. The imaging apparatus according to claim 13, wherein
the rotation center of each of the pairs of sun visors is disposed in a vertically central region of the lens, with the lateral direction of the imager being a vertical direction.

17. The imaging apparatus according to claim 13, wherein
each of the pair of sun visors has a folding fan structure,
each of the pair of sun visors comprises a shaft that serves as the rotation center, a blade that constitutes the rod-shaped member, and a shield member that is connected to the blade and displaceable with respect to the blade to to place the sun visor in either of an open fan state and a closed fan state, and
each of the pair of sun visors is placed in the open fan state by spreading the shield member in a direction of rotation of the sun visor.

18. The imaging apparatus according to claim 17, wherein
the sun visor device has a stowage mode, and
when the sun visor device is in the stowage mode, each of the pair of sun visors is swung into a stowage position by causing the shield member to be displaced in a direction opposite to a direction of spread of the shield member with respect to the blade, and placing the sun visor in the closed fan state.

19. The imaging apparatus according to claim 17, wherein
a lateral direction of the imager is a vertical direction,
in a standby position of the sun visor device where the pair of sun visors are positioned at an upper position of the lens, the shield member of each of the pair of sun visors spreads to place the sun visor in the open fan state, in which state the shield member blocks light from entering a portion of the lens,
in a stowage position of the sun visor device where the pair of sun visors are positioned at a lower position of the lens, the shield member of each of the pair of sun visors is displaced in a direction opposite to a direction of spread of the shield member with respect to the blade to place the sun visor in the closed fan state.

20. The imaging apparatus according to claim 19, further comprising:
a sun visor cover disposed on an opposite side of the pair of sun visors from the lens and configured to cover the pair of sun visors at least partially,
the sun visor cover comprises a frame having an opening formed to expose the pair of sun visors,
in the standby position of the sun visor device, the blade of each of the pair of sun visors is hidden between the frame and the lens, and
in the stowage position of the sun visor device, the shield member is in contact with the frame and displaced in the direction opposite to the direction of spread of the shield member.
